(19) United States
(12) Patent Application Publication
(10) Pub. No.: US 2023/0368143 A1
(43) Pub. Date: Nov. 16, 2023

(54) MULTI-USER PRODUCT CREATION SYSTEM

(71) Applicant: Amalgamate Digital, Inc., San Francisco, CA (US)

(72) Inventors: Susanne Millman Heim, Alameda, CA (US); Tania Michelle Treis, San Francisco, CA (US)

(21) Appl. No.: 18/196,709

(22) Filed: May 12, 2023

Related U.S. Application Data
(60) Provisional application No. 63/341,165, filed on May 12, 2022.

(51) Int. Cl. G06Q 10/10; G06F 40/166; G06Q 10/0631; G06Q 30/018

(52) U.S. Cl. CPC G06Q 10/103; G06F 40/166; G06Q 10/063118; G06Q 10/063114; G06Q 30/018; G06Q 50/26

(57) ABSTRACT

A system configured for collaborative project compliance data creation and storage. The system includes a user interface implemented in a network environment. The user interface includes user interface elements configured to receive user input, over the network, identifying geographical locations and project types. The system includes a data store, coupled to the user interface, comprising project tasks correlated with geographical locations and project types. The system includes a content management service coupled to the data store configured to generate an ordered list of project tasks based on the geographical location for the project and the project type.

### CROSS-REFERENCE TO RELATED APPLICATIONS

This application claims the benefit of and priority to U.S. Provisional Patent Application Ser. No. 63/341,165 filed on May 12, 2022 and entitled “Multi-User Collaborative Product Creation,” and which application is expressly incorporated herein by reference in its entirety.

### BACKGROUND

### Background and Relevant Art

When various projects are planned and constructed, environmental planning and regulatory compliance needs to be considered. The compliance requirements relate to project location and configuration or approach. Compliance requirements may be promulgated by federal, state, and/or local government entities. As might be expected, the compliance process often results in varied, complex, and extensive requirements for a given project. For example, a single project may have requirements related to aesthetics, agriculture and forestry resources, air quality, biological resources, cultural resources, energy, geology and soils, greenhouse gas emissions, hazard and hazardous materials, hydrology and water quality, land use and planning, mineral resources, noise, population and housing, public services, recreation, tribal and cultural resources, utilities and service systems, wildfire, etc.

Environmental planning and compliance typically require certain digital work products to be created. For example, environmental studies must be conducted to document, in certain databases, baseline conditions including developing of geographic information system (GIS) datasets, environmental analyses are conducted to evaluate and document project effects in certain databases, project plans (such as, in some embodiments, environmental documents) are prepared and digitally stored to document the project effects and mitigation requirements, and compliance with mitigation and permit conditions are documented and digitally stored in the field during construction. The multi-step planning process requires development, tracking and collaboration of digitally stored project plans including coordinating disparate digitally stored groups of tasks to be performed to ensure all steps in the documentation and compliance process have been completed.

Environmental planning and compliance document preparation, review, and tracking of the overall process and tasks typically involves multiple interested parties, including project proponents, multiple stakeholders, agencies, and the general public. To collect the required data, prepare the required documentation, and accomplish compliance tasks related to requirements, multiple computing systems used by multiple users and teams of users collaborate to ensure that all tasks and steps in the compliance process are performed.

As a result of the breadth of systems and organizations involved in environmental planning and compliance, there are multiple friction points and multiple opportunities for errors. Indeed, the mere fact that different, diverse users are involved creates a friction point. For example, while environmental planning and compliance systems often requires consistent descriptions and correlated actions across categories of tasks and documents or reports, the presence of diverse users with a range of interests in the project often causes diverse actions to be taken where consistency is not met. Further, there are often sets of tasks that must be complete before other tasks can be undertaken or completed. Users and teams that are overly enthusiastic, and/or systems without coordinating control, may begin or complete tasks too early resulting in wasted effort when tasks must be redone in proper order, or risk noncompliance. Alternatively, systems may wait in indecision because their action depends on others taking action first, and then overall timelines and goals are not met if those systems are not appropriately notified in a timely fashion.

Further, a typical project plan is a sort of master document stored in a fashion that is antithetical to simultaneous collaboration. In particular, a master authoritative document should be stored and tightly controlled to ensure consistency, accuracy, etc., but allowing multiple users and teams to generate and/or edit such a document can result in inconsistencies and inaccuracies. Further, even the task of sharing such a document to allow other users and teams to update the document creates additional technical difficulties. For example, transmitting a single authoritative copy of the document from entity to entity for updating creates a constricted bottleneck slowing generation of essential portions of the document.

Further still, another technical problem arises in such document creation due to the vast diversity of project locations and associated characteristics of such locations. In particular, each distinct geographic location will have characteristics that differ from other locations. Identifying these different characteristics requires multiple different subject matter experts interacting with multiple different databases to identify such characteristics. Once the multiple characteristics have been identified, these characteristics must be somehow synthesized into the stored project plan and the requirements therein.

Thus, as illustrated, there are several technical problems related to environmental planning and compliance project plan generation and maintenance.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a system diagram;

FIG. 2 illustrates a login user interface screen;

FIG. 3 illustrates a project user interface screen;

FIG. 4 illustrates a blank project management user interface screen;

FIG. 5 illustrates a populated project management user interface screen;

FIG. 6 illustrates a biological resources task user interface screen;

FIG. 7 illustrates a mitigation measures text user interface;

FIG. 8 illustrates a map user interface screen;

FIG. 9 illustrates a site analyzation user interface screen;

FIG. 10 illustrates a project configurator interface;

FIG. 11 illustrates a project workspace user interface screen;

FIG. 12 illustrates a document collaboration user interface screen;

FIG. 13 illustrates a stakeholder engagement user interface screen;

FIG. 14 illustrates a comment synthesis user interface screen;

FIG. 15 illustrates an implementation tracking user interface screen;

FIG. 16 illustrates an administrative record user interface screen; and

FIG. 17 illustrates a method of generating a project compliance document.

### DETAILED DESCRIPTION

Embodiment illustrated herein are directed to systems and method for collaborative project compliance document generation and storage. For example, embodiments may include hardware and software for displaying a user interface in a network environment. The user interface includes user interface elements configured to receive user input identifying geographical locations and project types. Further, the user interface includes user interface elements configured to receive user input specifying a geographical location for a project. The user interface further includes functionality for receiving user input specifying a project type for the project. An identifier can be identified for the project. A content management service is configured to access a data store that includes project tasks correlated with geographical locations and project types. The content management service is further configured to generate an ordered list of project tasks based on the geographical location for the project and the project type. The content management service is further configured to identify discrete groups of tasks from the ordered list of project tasks, including identifying a first discrete group for which completion is foundational before completion of a second discrete group. The content management service is further configured to identify and assign users to the discrete groups. The content management service is further configured to receive user input, through the user interface, for users assigned to the first discrete group to complete tasks in the first discrete group. The content management service is further configured to identify that the tasks in the first discrete group have been performed. As a result, the content management service is further configured to transmit a notification message over the network to users assigned to the second discrete group indicating that the users in the second discrete group can perform tasks in the second discrete group. Note that notifications may be alerts in an app or operating system, email notifications, text messages, automated phone calls, and/or by other appropriate means. The content management service is further configured to identify that all tasks in the ordered list of project tasks have been completed. As a result, the content management service is further configured to generate a project compliance document from information entered during completion of the discrete groups of tasks.

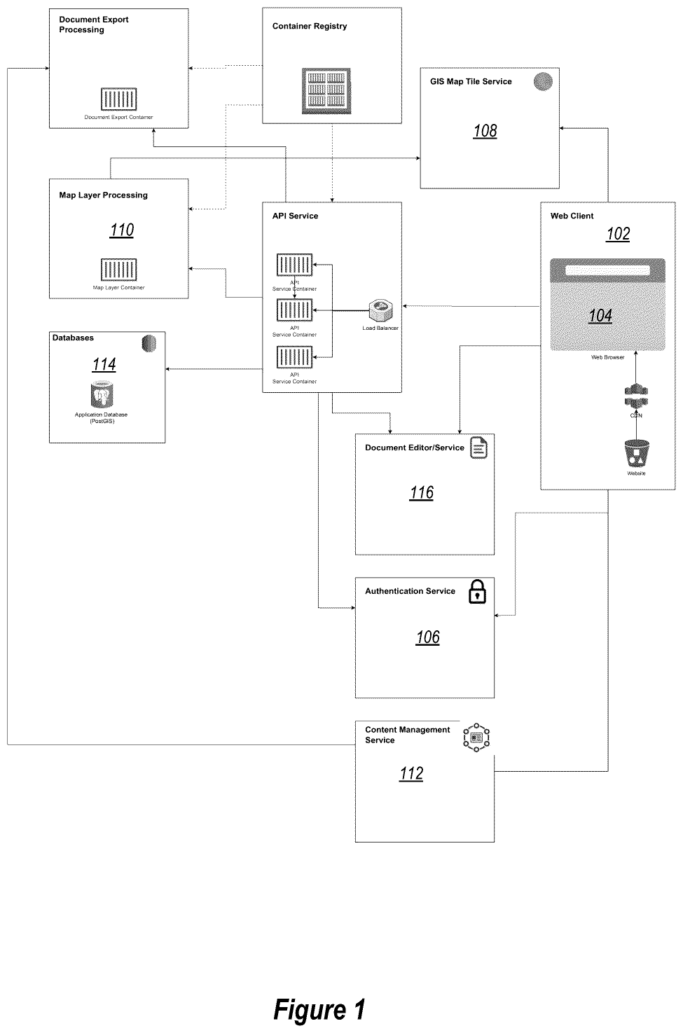

Referring now to FIG. 1, an example system where embodiments may be implemented is illustrated. FIG. 1 illustrates a web client 102. The web client 102 may be installed on a personal computing system, such as a desktop, laptop, tablet, phone, or other system. The web client 102 may use a browser or specialized application. FIG. 1 illustrates that a web browser 104 is used. The web browser 104 (or other application) can be used by a user to access and interact with the other components shown in FIG. 1.

The following discussion illustrates how a user interacts with the system of FIG. 1. Reference will be made to various screens illustrated in a user interface.

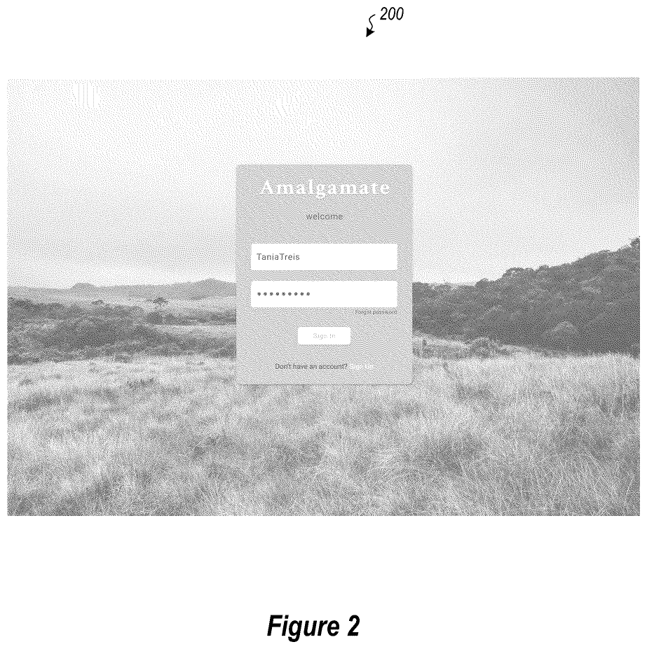

With reference to FIG. 2, a user accesses a login screen 200 of a user interface. The login screen 200 may be provided by a content delivery network and/or a website, but allows the user to access an authentication service 106 to provide appropriate credentials to allow the user to access the various parts of the system.

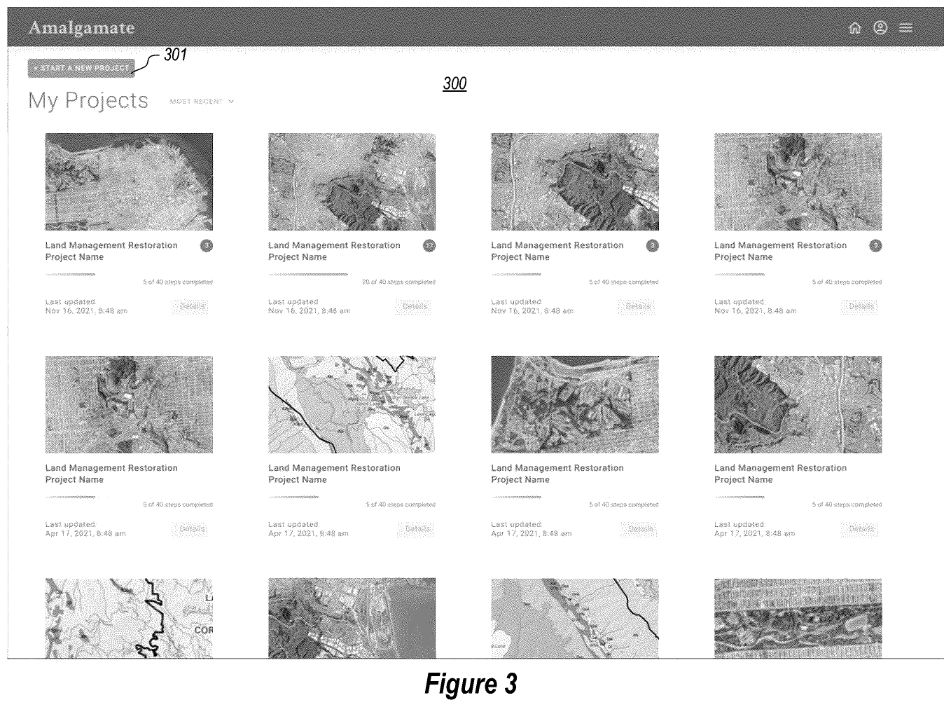

Once a user has been properly authenticated, the user can access various other screens of the user interface. For example, in some embodiments, a user may land on a project screen 300 showing various projects with which the user is associated. Here, a user may select a given project to perform tasks associated with the project, monitor project status, or perform other appropriate actions. FIG. 3 illustrates a “start new project” button 301. By selecting this button in the user interface, the user will be able to provide sufficient information to begin project compliance data creation, in the form of a project compliance document. In particular, in the example illustrated, the user will be able to specify a project type and specify a geographical location for the project type. With these two pieces of information, the system can identify project tasks correlated with geographical locations and project types.

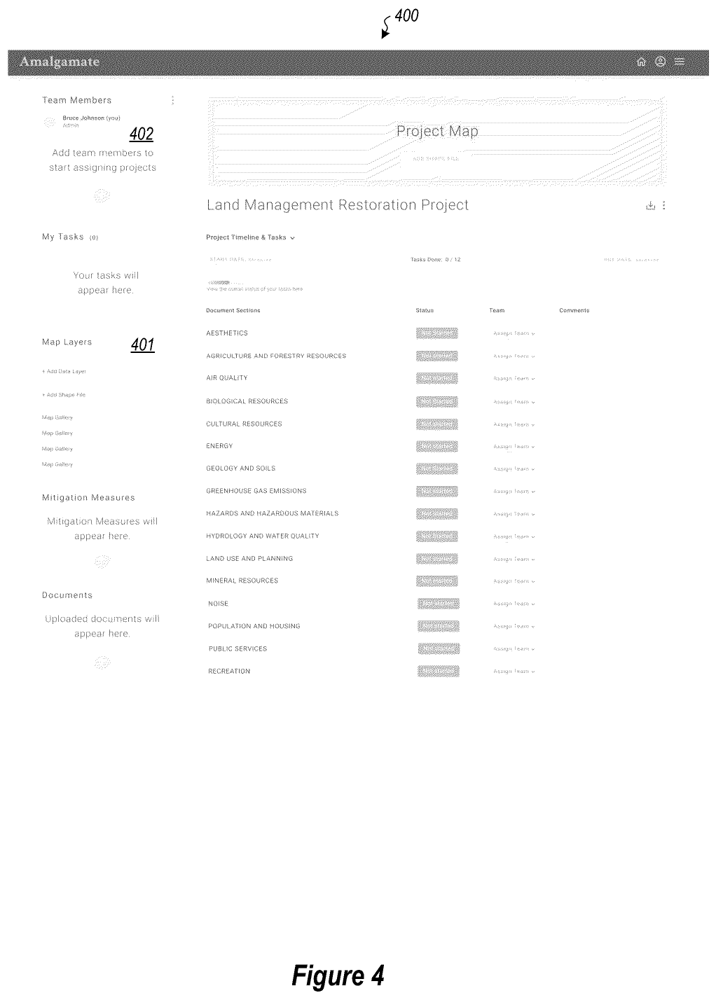

Reference is now made to FIG. 4, which illustrates a blank project management screen 400. Here, a user can specify the project type, which in this example, is a restoration project. Additionally, the user can specify a geographical location. In the example illustrated in FIG. 4, the user can add various map layers to specify the geographical location. For example, FIG. 4 illustrates a map layers interface element 401. Here, a user can add data layers (e.g., quantitative and/or descriptive data tied to geographic location) and shape files (e.g., geographic information system location data). As illustrated in FIG. 1, the web client 102 is coupled to a GIS map tile service 108. In particular, the GIS map tile service 108 in conjunction with the map layer processing service 110 allows a user to select different map layers for a particular geographical location to add to a project. Thus, the user can select coordinates and desired layers. Such layers may include, for example, a topographic layer, a tax parcel layer, a zoning layer, a floodplains layer, a wetlands layer, a land cover layer, a soils layer, a transportation layer, a structures layer, and/or other layers.

Based on the location information and project type information, the content management service 112 creates an ordered list of project tasks for compliance document creation. In particular, the diverse information in the various layers for a particular geographical location, along with the type of project, is used by the system to generate standardized tasks that need to be performed for compliance document creation. In some embodiments, portions of the project compliance document can be automatically generated based simply on geographic location information for the project and project type.

As illustrated in FIG. 4, the tasks can be partitioned in a number of different fashions. In one partitioning, the tasks are automatically partitioned by document section. Thus, as illustrated in the particular example, different partitions of tasks are generated for aesthetics, agriculture and forestry resources, air quality, biological resources, cultural resources, energy, geology and soils, greenhouse gas emissions, hazard and hazardous materials, hydrology and water quality, land use and planning, mineral resources, noise, population and housing, public services, recreation, tribal and cultural resources, utilities and service systems, wildfire, etc.

Additionally, or alternatively, tasks may be partitioned according to required ordering. For example, the content management service may identify a first discrete group of tasks for which completion is foundational before completion of a second discrete group of tasks. The content management service 112 can track task completion to ensure that groups of tasks are completed in order.

Note that given the massive scope of most project compliance document creation undertakings, multiple different users and/or teams of users will work collaboratively to prepare the project compliance document. Thus, embodiments illustrated herein can coordinate these users and teams to ensure that tasks and groups of tasks are performed in proper order although multiple different entities are working on the document. For example, embodiments may store document creation tasks in one or more databases 114.

Entities are notified via network messages when it is an appropriate time for those entities to perform tasks. For example, in some embodiments, a message can be sent to entities notifying them that the first group of foundational tasks can be performed. User input is then received from users assigned to the first discrete group of tasks to complete tasks in the first discrete group of tasks. When the first set of foundational tasks has been performed, the content management service 112 detects this condition, and generates a notification message. This generated notification message is sent to users assigned to the second discrete group of tasks indicating that the users assigned to the second discrete group of tasks can perform tasks in the second discrete group. This process continues for other discrete groups of tasks where the system ensures foundational tasks are completed first before notifying user to perform tasks dependent on foundational tasks. Once the content management service 112 detects that all tasks for the project compliance document creation have been performed, the project compliance document is generated.

Additional details are now illustrated with respect to task performance.

Referring once again to FIG. 4, the screen 400 includes a team selection user interface 402. Here, users for a project can be manually or automatically added. Note that in some embodiments, the creator of the document will be automatically added to the document. In some embodiments, a user can access various databases of users to add them as team members to the project. Note that in some embodiments, various additional tools can be used to suggest team members. For example, in some embodiments, previous team members from previous projects can be suggested for inclusion. Alternatively, or additionally, some embodiments may be connected to recruiting web sites, social media sites, or other sites. Embodiments may include functionality for matching needed skills for a document creation project with those seeking employment and/or those with known skills. These can be suggested as team members to add to a project.

Note that embodiments may include functionality for adding specific users as team members. Alternatively, or additional, embodiments may include functionality for adding roles as a team member, rather than a specific team member. Alternatively, or additionally, embodiments may include functionality for including team members from lists of team members for previous projects.

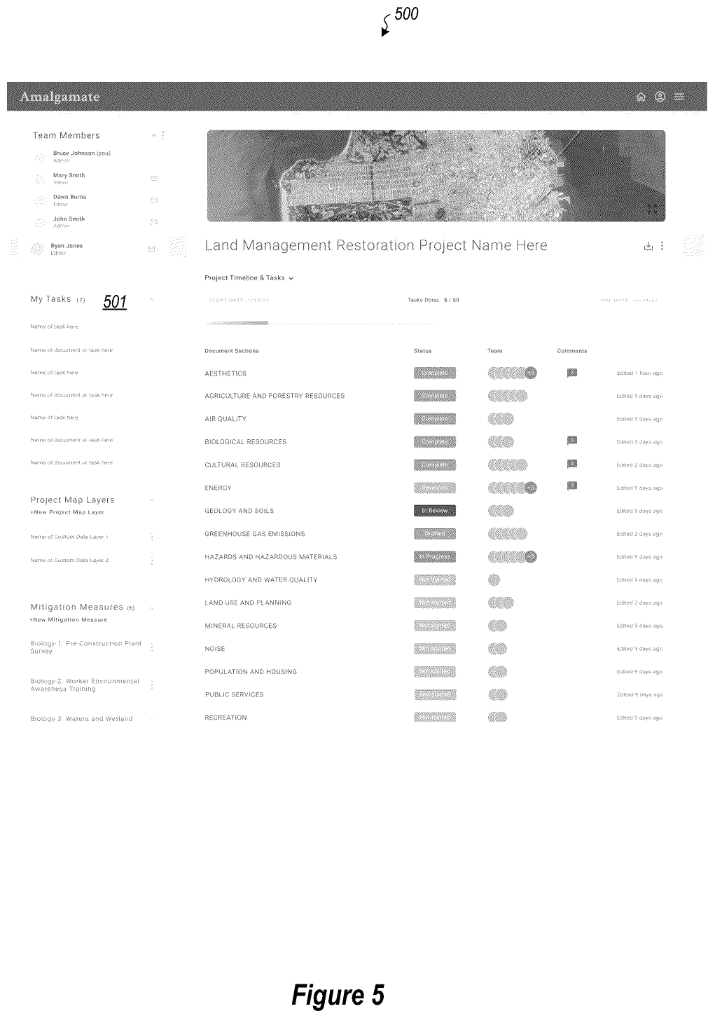

Referring now to FIG. 5, a populated project management screen 500 is illustrated. In this example, a project type has been selected, a location has been selected, tasks have been generated, and team members have been added. In this screen 500 a user can see progress for document sections, team members for document sections, comments, task assigned to a particular user, project map layers, mitigation measures, etc.

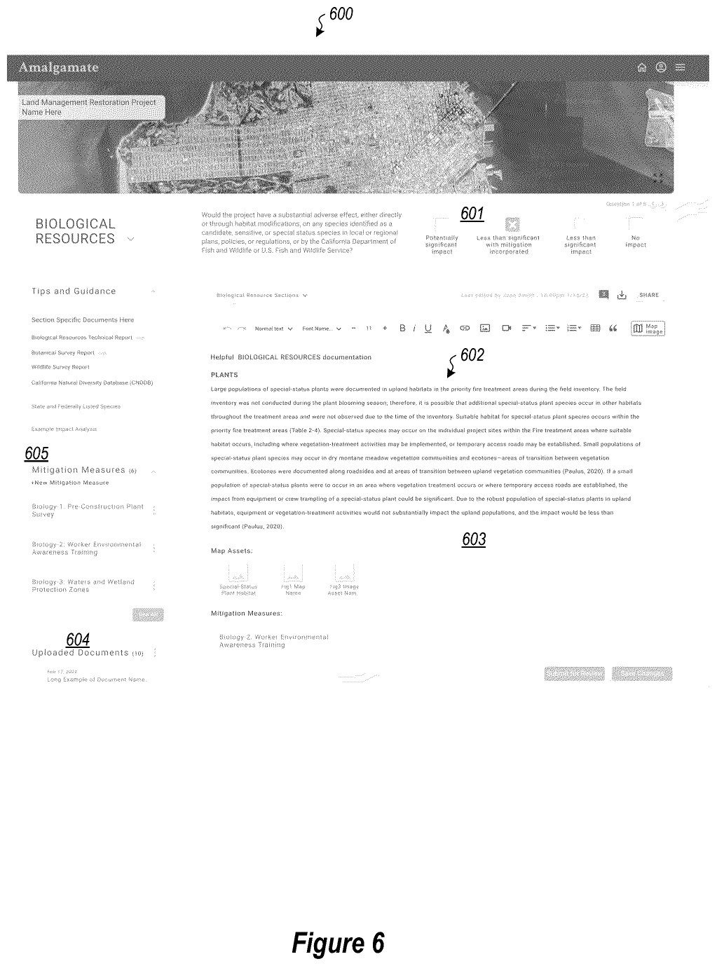

Assume a user has received a message indicating that they are able to perform a task. The user can select the task from the “My Task” interface 501. For example, with reference to FIG. 6, the user may select interface elements to perform tasks associated with biological resources. A task screen 600 is displayed to the user. This screen 600 has several useful tools to guide the user through various tasks. For example, the task screen 600 includes a question wizard interface 601 that walks the user through various questions to collect response that are then used to suggest information to the user to help the user fill in portions of the compliance document.

For example, by the user simply selecting the “Less than significant with mitigation incorporated” checkbox in response to question 1 in the question wizard interface 601, the text 602 is automatically populated into the documentation interface 603 for addition to the compliance document. Further, supporting documents can be automatically added to the uploaded documents interface 604 and relevant mitigation measures can be automatically added to the mitigation measures interface 605. Note the documentation interface 603 is editable, such that the text that is automatically populated can be edited. In some embodiments, this may be accomplished by using a document editor/service 116 as illustrated in FIG. 1.

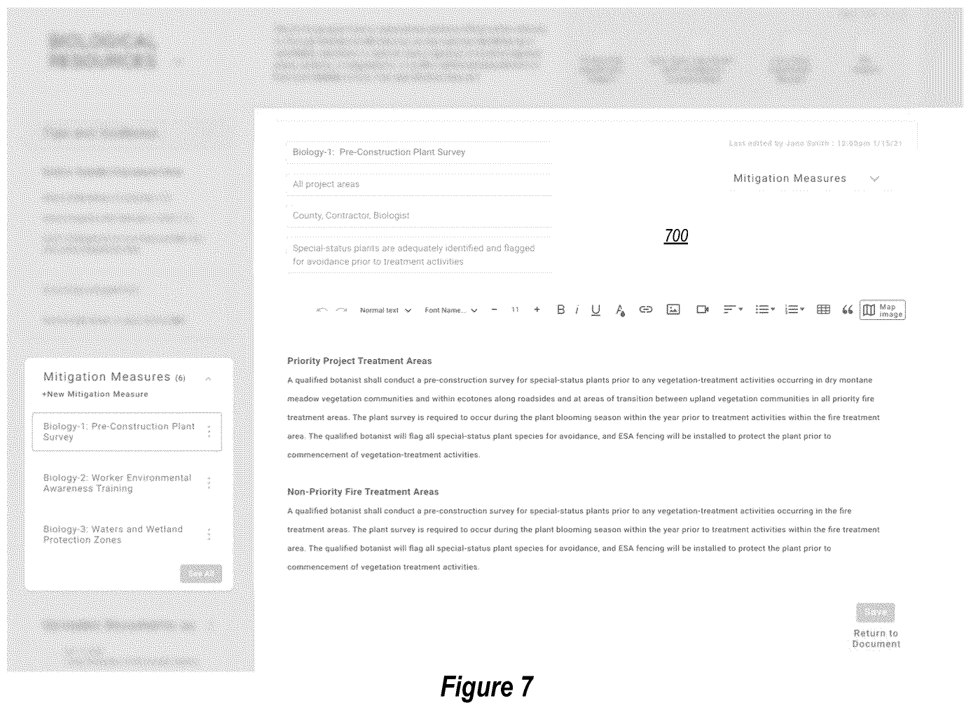

Further, additional uploaded documents, mitigation measures, etc. can be further edited by the user. For example, FIG. 7 illustrates a mitigation measures text interface 700. Here, mitigation measures may be pre-populated based on questions answered by the user as previously illustrated. However, embodiments include the ability to edit the mitigation measures using a word processing interface as illustrated in FIG. 7. This may be facilitated by using the document editor/service 116 as illustrated in FIG. 1.

Some embodiments are configured to cause the content management service to automatically identify discrepancies in portions of the project compliance document requiring correlated content and as a result, automatically transmit a notification message over the network to alert a user, of the discrepancy.

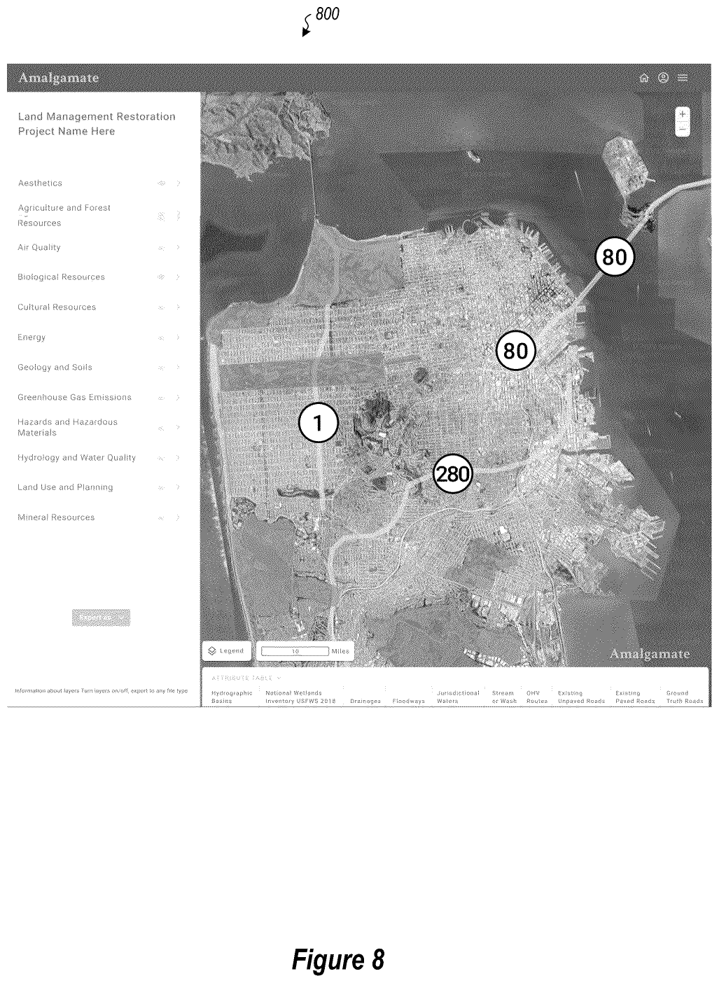

Referring now to FIG. 8, a map screen is illustrated. The map screen 800 can be used to correlate tasks with geographical locations.

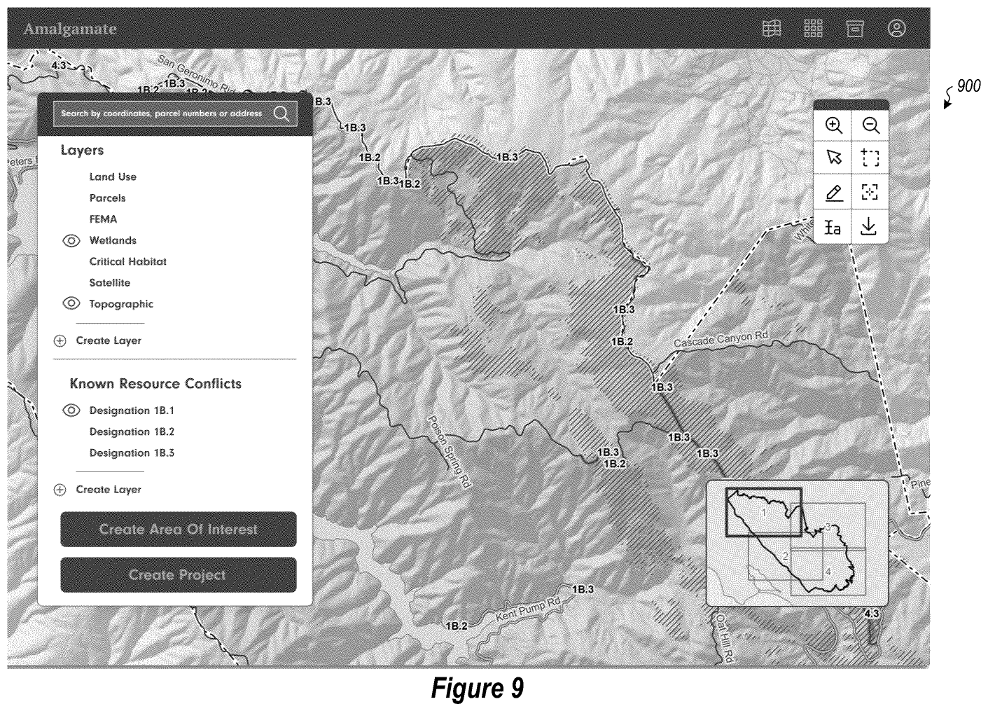

Referring now to FIGS. 9-16, additional and/or alternative examples of user interface screens are illustrated.

FIG. 9 illustrates a site analyzation screen 900 of a user interface. This screen includes a map-based interface for easily gathering data on pre-existing conditions and key resource issues. Further, embodiments may include functionality for identification of potential implementation requirements based on geographic components. Further, embodiments may include functionality for identification of site-specific topics of concern. Further, embodiments may include functionality for hosting a central repository for data collection and modeling. Mapping functionality includes easy to use layers, drawing and annotation tools, and shape file uploading.

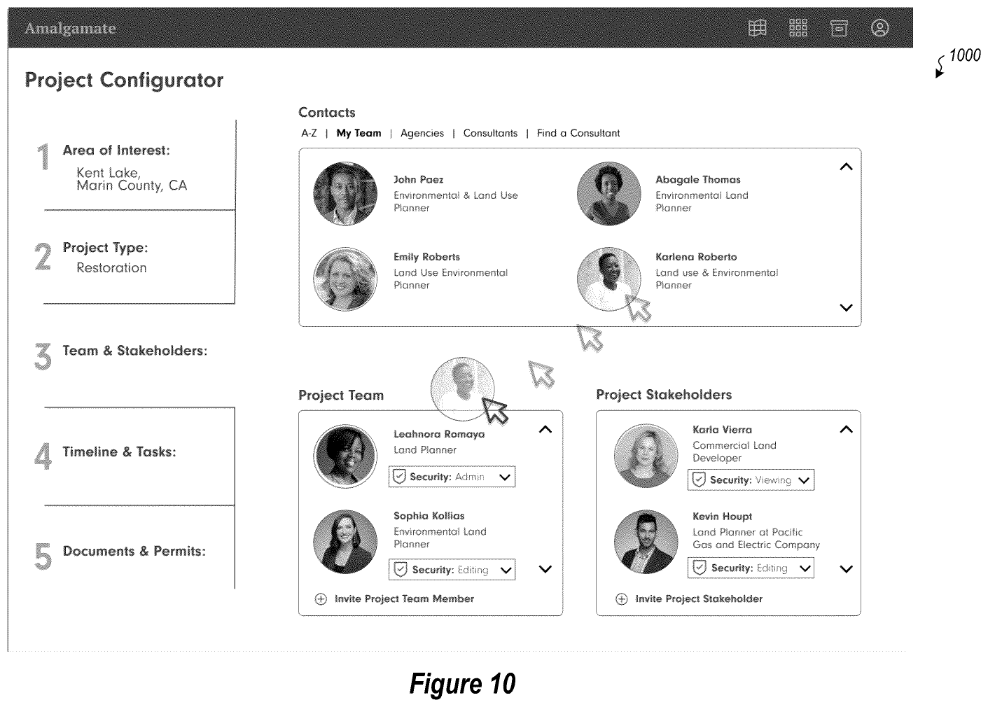

FIG. 10 shows a project configurator interface 1000. Here, a user can select an area of interest, identify a project type, define a project team and/or interested stakeholders, view and/or edit timelines and tasks, view and/or upload documents and permits, etc. Embodiments may include “wizard” like step-by-step project configuration based on location, and project type. Embodiments may implement customizable preconfigured workspaces which provide local permit applications, document templates, and a ‘prefilled’ timeline. Embodiments may include a drag and drop interface for project team creation and/or project stakeholder definition. Embodiments may include a simple interface to identify and source qualified local consultants and subject matter experts.

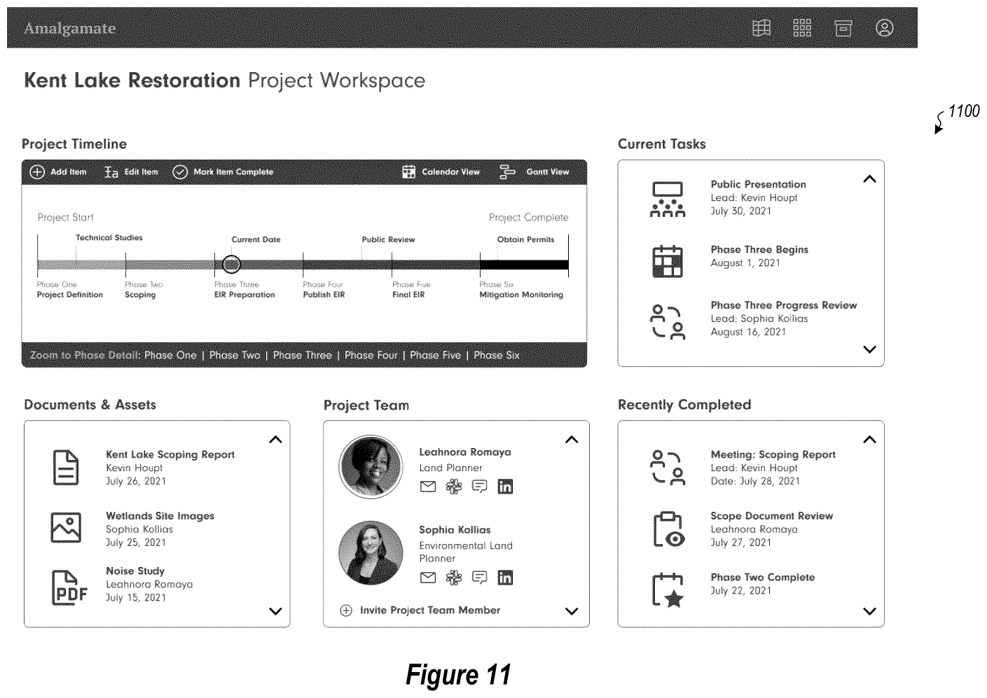

FIG. 11 illustrates a project workspace screen 1100 of the user interface. The project workspace screen 1100 provides at-a-glance project tracking and insights via a customizable dashboard. The project workspace screen 1100 provides personalized views of tasks and deadlines. The project workspace screen 1100 provides instant access to project files and assets. The project workspace screen 1100 provides instant communication with project team members.

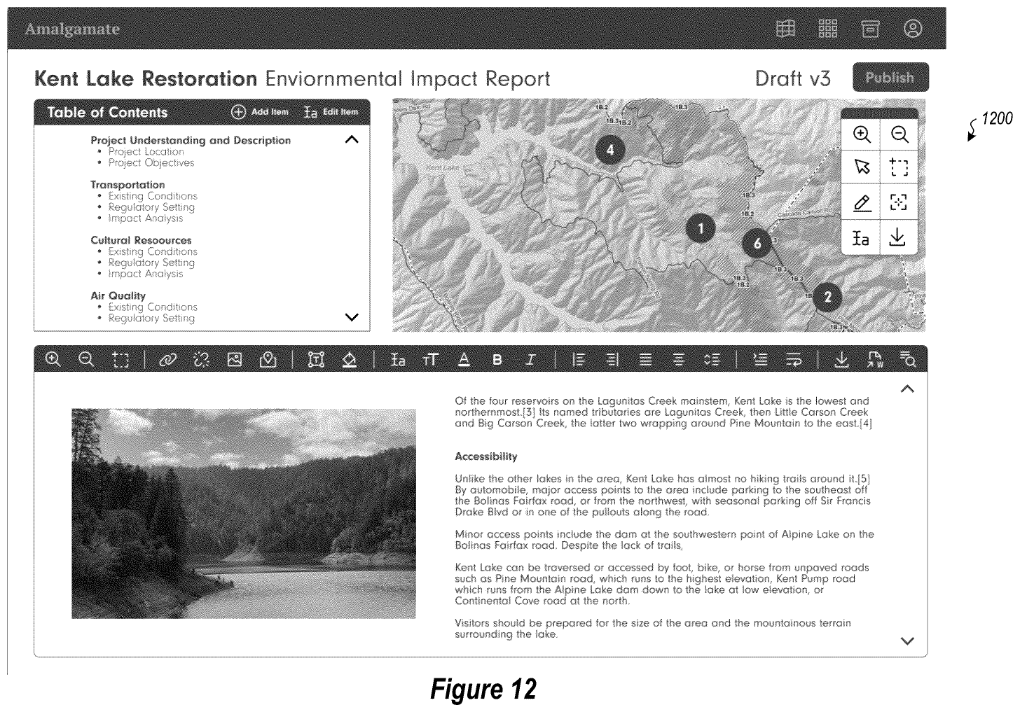

FIG. 12 illustrates a document collaboration screen 1200 of the user interface. The document collaboration screen 1200 provides instant access to guidelines, case law, and technical advisories. The document collaboration screen 1200 provides customizable templates for exemptions, declarations, environmental impact reports, etc. The document collaboration screen 1200 provides quick access to customizable libraries of figures, standardized language, and definitions. The document collaboration screen 1200 provides seamless interoperability between maps, figures, and documents.

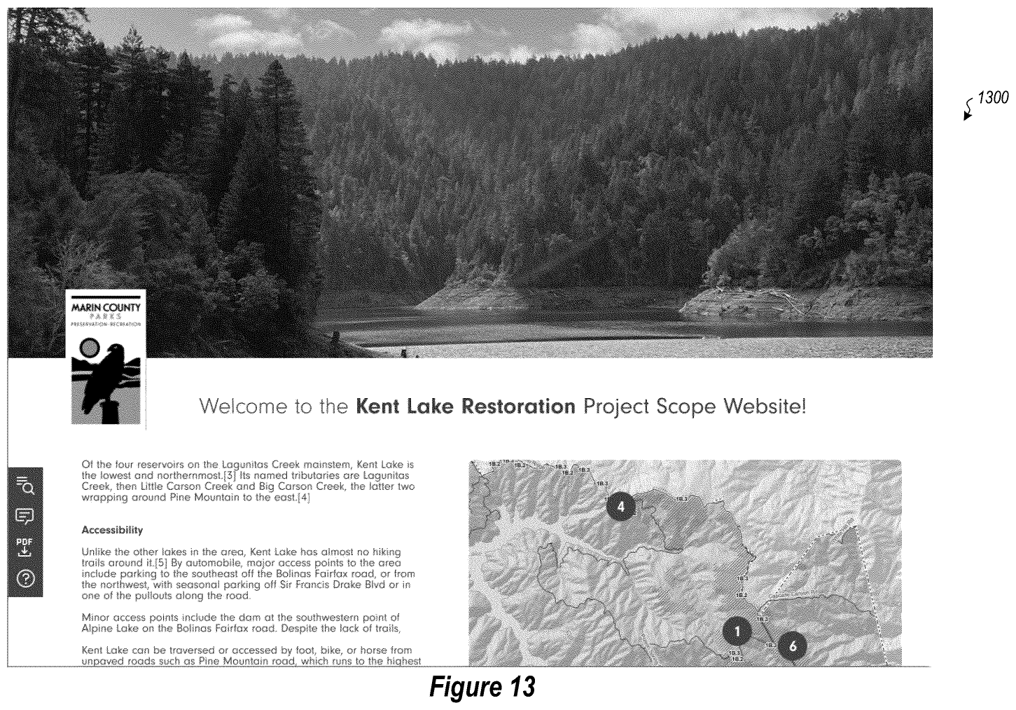

FIG. 13 illustrates a stakeholder engagement screen 1300 of the user interface. The stakeholder engagement screen 1300 implements an ‘instant’ deployment and cloud-based hosting of a project website. The stakeholder engagement screen 1300 provides easy-to-use tools for project stakeholders and the general public to add comments, search for specific items and download available documents.

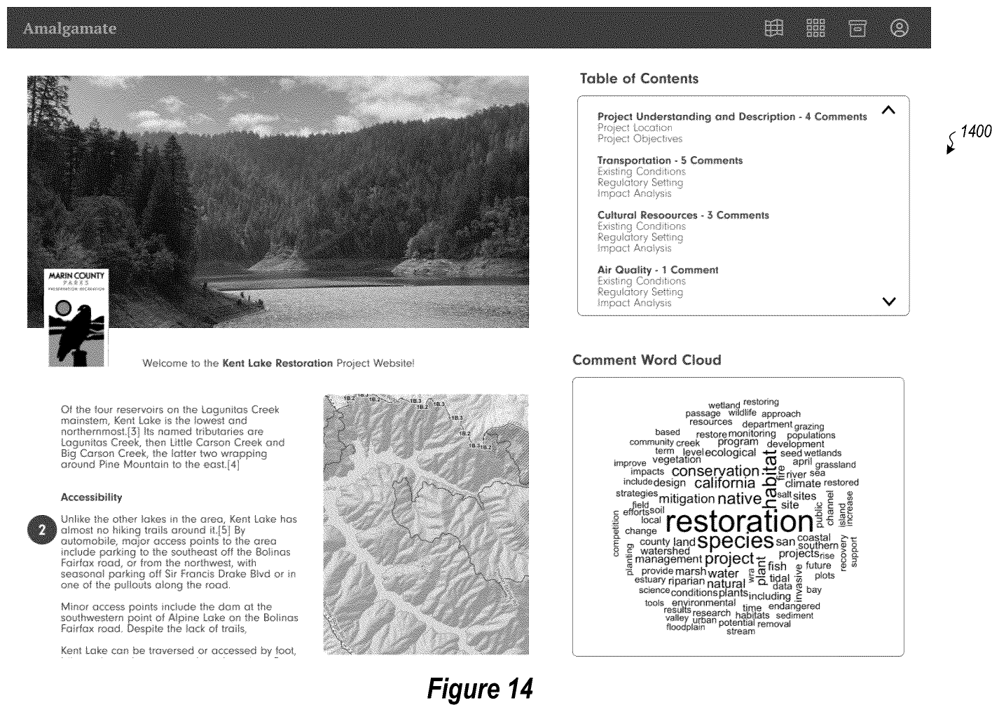

FIG. 14 illustrates a comment synthesis screen 1400 of the user interface. The comment synthesis screen 1400 is used to gather and review stakeholder and public input. The comment synthesis screen 1400 may include an automatically generated word cloud or other display element to viewers to understand the frequency of key words and phrases. In particular, this creates a more efficient user interface in that summarizations of multiple concepts can be seen in a single view of the user interface without needing to scroll through the individual comments themselves. In some embodiments, the comment synthesis screen 1400 implements a table-of contents-based scanning and targeting of comments.

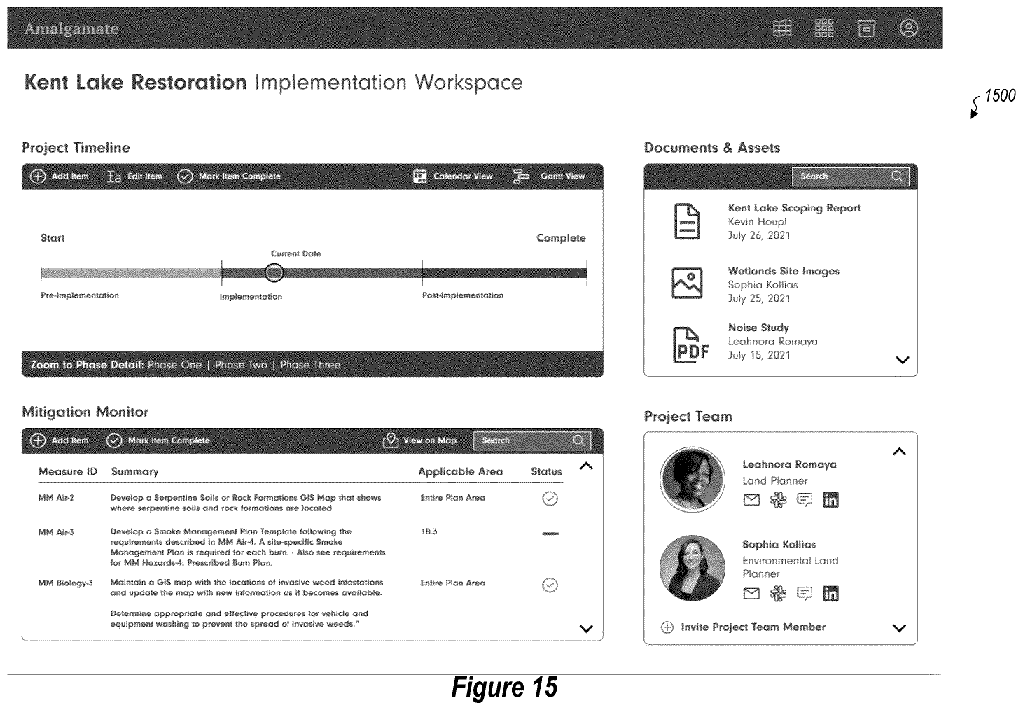

FIG. 15 illustrates an implementation tracking screen 1500 of the user interface. The implementation tracking screen 1500 is configured to facilitate easy capture and documentation of compliance for project changes that may occur. The implementation tracking screen 1500 is configured to facilitate compliance tracking, including facilitating reporting streamlining and repositories.

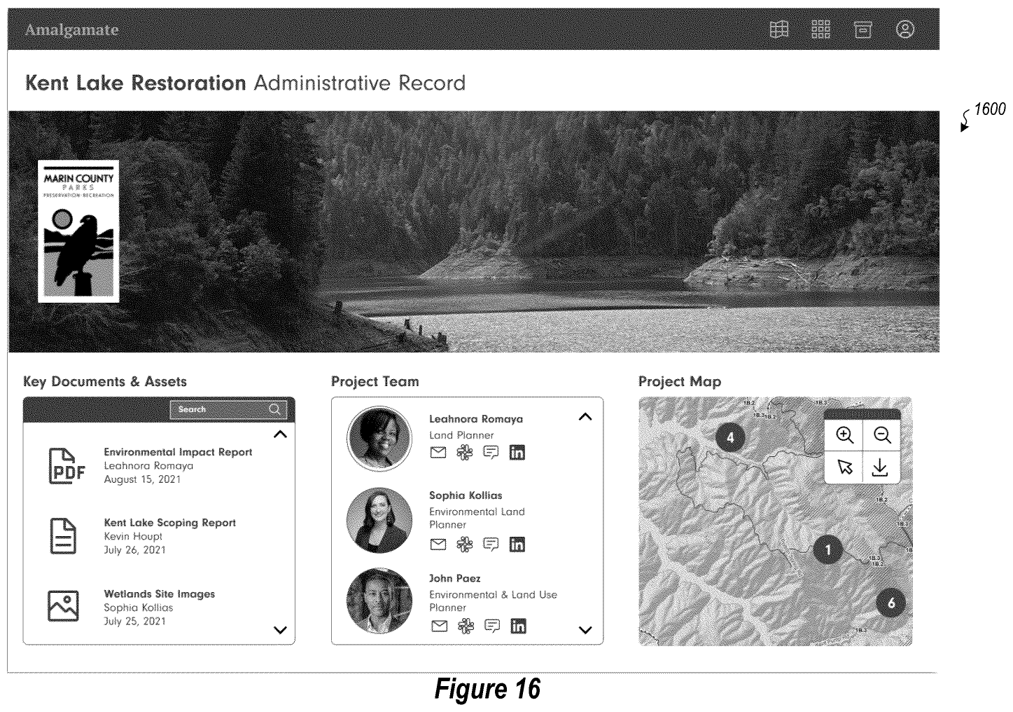

FIG. 16 illustrates an administrative record screen 1600 of the user interface. The administrative record screen displays an automatically generated and customizable administrative record for project files, project team members, compliance, spatial views over time (via satellite). A strengthened administrative record will significantly reduce valid legal challenges and costs associated with challenges.

Some embodiments may include user interface elements that display a file list and allows users access to files including one or more of reports, images, studies, legal documents, guidelines, or technical advisories.

Thus, embodiments illustrated herein facilitate creation of a cloud-based document, process, asset, communications and comment review management; real-time collaboration for stakeholders and contributors; easily accessed templates and tips, standardized text, and previously approved mitigation; dynamic content updates —easily access the most current version of documents, while keeping a secure record of the past.

Note that some embodiments include functionality for “reverse engineering” project compliance documents. In particular, in some embodiments, a project compliance document can be uploaded to the content management service 112. The content management service 112 can identify various characteristics of the document, including geographical location and project type, as well as the information in the project compliance document related to aesthetics, agriculture and forestry resources, air quality, biological resources, cultural resources, energy, geology and soils, greenhouse gas emissions, hazard and hazardous materials, hydrology and water quality, land use and planning, mineral resources, noise, population and housing, public services, recreation, tribal and cultural resources, utilities and service systems, wildfire, etc. Based on the information included in the document, embodiments can then use the various databases and services in the system to identify relevant compliance information and mitigation measure requirements.

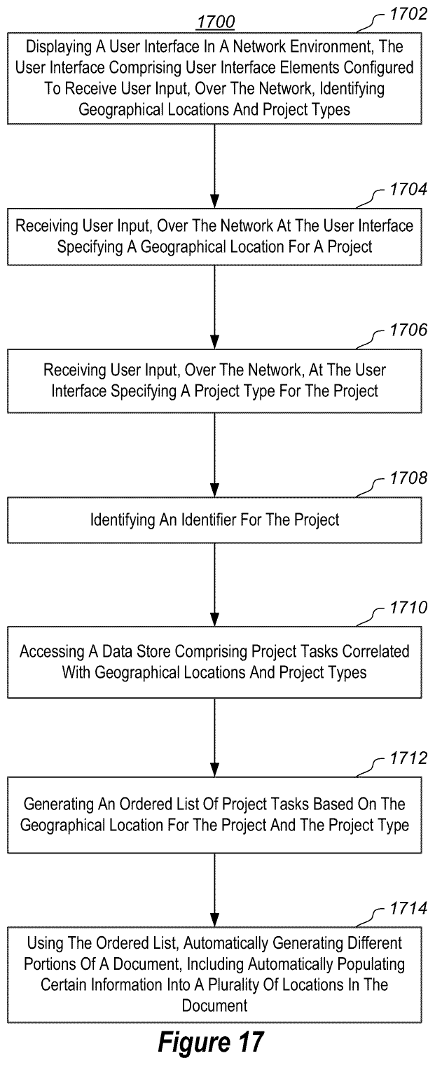

Referring now to FIG. 17, a method 1700 is illustrated. The method 1700 includes acts for data creation. The method includes displaying a user interface in a network environment, the user interface comprising user interface elements configured to receive user input, over the network, identifying geographical locations and project types (act 1702).

The method 1700 further includes receiving user input, over the network at the user interface specifying a geographical location for a project (act 1704).

The method 1700 further includes receiving user input, over the network, at the user interface specifying a project type for the project (act 1706).

The method 1700 further includes identifying an identifier for the project (act 1708).

The method 1700 further includes accessing a data store comprising project tasks correlated with geographical locations and project types (act 1710). Note that in some embodiments, the data store may include a method for streamlining environmental compliance for projects covered under the California Vegetation Treatment Program (CalVTP) prepared by The California Board of Forestry and Fire Protection.

The method 1700 further includes generating an ordered list of project tasks based on the geographical location for the project and the project type (act 1712).

The method 1700 further includes using the ordered list, automatically generating different portions of a document, including automatically populating certain information into a plurality of locations in the document (act 1714). For example, the documents may have several different sections, such as mitigation sections, executive summary sections, and the like which will include portions of the same information. Thus, embodiments can pre-populate document sections with information, including some sections having the same information as other sections. Thus, the compliance process is streamlined where specific information is automatically entered without requiring a user to manually enter the information. In some embodiments, this ensures that the information, especially duplicate information, is entered into the correct location in the document and is consistent throughout the document without the user needing to specifically navigate to those different portions of the document.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system configured for collaborative project compliance data creation and storage, the system comprising:
a user interface implemented in a network environment, the user interface comprising user interface elements configured to receive user input, over the network, identifying geographical locations and project types;
a data store, coupled to the user interface, comprising project tasks correlated with geographical locations and project types; and
a content management service coupled to the data store configured to generate an ordered list of project tasks based on the geographical location for the project and the project type.

2. The system of claim 1, wherein the content management service is further configured to:
identify discrete groups of tasks from the ordered list of project tasks, including identifying a first discrete group for which completion is foundational before completion of a second discrete group;
identify and assign users to the discrete groups;
receive user input for users assigned to the first discrete group to complete tasks in the first discrete group;
identify that the tasks in the first discrete group have been performed;
transmit a notification message over the network to users assigned to the second discrete group indicating that that the users assigned to the second discrete group can perform tasks in the second discrete group;
identify that all tasks in the ordered list of project tasks have been completed; and
as a result, generate a project compliance document from information entered during completion of the discrete groups of tasks.

3. The system of claim 1, the user interface comprising user interface elements configured to receive map layer data at the user interface, the map layer data comprising at least one of data layers or shape files defining the project location, and wherein the content management service is configured to identify tasks based on the data layers or shape files defining the project location to be included in the ordered list of project tasks.

4. The system of claim 1, the user interface comprising user interface elements configured to display a file list allowing users access to files including one or more of reports, images, studies, legal documents, guidelines, or technical advisories.

5. The system of claim 1, the user interface comprising user interface elements configured to receive user input, over the network, comprising stakeholder or public comments for the project.

6. The system of claim 5, wherein the content management service is further configured to identify frequency of words and phrases in the comments and display in the user interface an indication of the frequency of the comments.

7. The system of claim 1, the user interface comprising user interface elements configured to receive user input at a wizard user interface element, and as a result, the content management service is configured to automatically generate portions of a project compliance document.

8. The system of claim 7, wherein the user interface is further configured to display the automatically generated portions of the project compliance document in a word processing interface to allow a user to edit the automatically generated portions in the project compliance document.

9. The system of claim 1, wherein the content management service is further configured to automatically identify discrepancies in portions of a project compliance document requiring correlated content and as a result, automatically transmitting a notification message over the network to alert a user of the discrepancy.

10. A method of collaborative project compliance data processing and storage, the method comprising:
displaying a user interface in a network environment, the user interface comprising user interface elements configured to receive user input, over the network, identifying geographical locations and project types;
receiving user input, over the network at the user interface specifying a geographical location for a project;
receiving user input, over the network, at the user interface specifying a project type for the project;
accessing a data store comprising project tasks correlated with geographical locations and project types; and
generating an ordered list of project tasks based on the geographical location for the project and the project type.

11. The method of claim 10, further comprising using the ordered list, automatically generating different portions of a document, automatically populating data into a plurality of locations of the document.

12. The method of claim 10, further comprising:
identifying discrete groups of tasks from the ordered list of project tasks, including identifying a first discrete group for which completion is foundational before completion of a second discrete group;
identifying and assigning users to the discrete groups;
receiving user input for users assigned to the first discrete group to complete tasks in the first discrete group;
identifying that the tasks in the first discrete group have been performed;
transmitting a notification message over the network to users assigned to the second discrete group indicating that that the users assigned to the second discrete group can perform tasks in the second discrete group;
identifying that all tasks in the ordered list of project tasks have been completed; and
as a result, generating a project compliance document from information entered during completion of the discrete groups of tasks.

13. The method of claim 10, further comprising receiving map layer data at the user interface, the map layer data comprising at least one of data layers or shape files defining the project location, and as a result, identifying tasks based on geographic location to be included in the ordered list of project tasks.

14. The method of claim 10, further comprising displaying a file list and allowing users access to files including one or more of reports, images, studies, legal documents, guidelines, or technical advisories.

15. The method of claim 10, further comprising receiving user input, over the network, at the user interface, comprising stakeholder or public comments for the project.

16. The method of claim 15, further comprising identifying frequency of words and phrases in the comments and displaying in the user interface an indication of the frequency of the comments.

17. The method of claim 10, further comprising receiving user input at a wizard user interface element, and as a result, automatically generating portions of a project compliance document.

18. The method of claim 17, further comprising displaying the automatically generated portions of the project compliance document in a word processing interface to allow a user to edit the automatically generated portions in the project compliance document.

19. The method of claim 10, further comprising automatically identifying discrepancies in portions of a project compliance document requiring correlated content and as a result, automatically transmitting a notification message over the network to alert a user of the discrepancy.

20. A computer readable storage medium comprising computer executable instructions that when executed by one or more processors causes the one or more processors to implement collaborative project compliance data creation and storage including instructions configured to cause the processors to perform the following:
displaying a user interface in a network environment, the user interface comprising user interface elements configured to receive user input, over the network, identifying geographical locations and project types;
receiving user input, over the network at the user interface specifying a geographical location for a project;
receiving user input, over the network, at the user interface specifying a project type for the project;
accessing a data store comprising project tasks correlated with geographical locations and project types; and
generating an ordered list of project tasks based on the geographical location for the project and the project type.
